(19) United States
(12) Patent Application Publication
(10) Pub. No.: US 2014/0152532 A1
(43) Pub. Date: Jun. 5, 2014

(54) PANEL VIDEO SYSTEM CONTROLLER AND LCD DEVICE

(71) Applicants: Yinhung Chen, Shenzhen (CN); Liangchan Liao, Shenzhen (CN); Poshen Lin, Shenzhen (CN)

(72) Inventors: Yinhung Chen, Shenzhen (CN); Liangchan Liao, Shenzhen (CN); Poshen Lin, Shenzhen (CN)

(73) Assignee: SHENZHEN CHINA STAR OPTOELECTRONICS TECHNOLOGY CO., LTD, Shenzhen (CN)

(21) Appl. No.: 13/704,606

(22) PCT Filed: Nov. 15, 2012
(86) PCT No.: PCT/CN2012/084632

§ 371 Date: Dec. 14, 2012

(30) Foreign Application Priority Data
Sep. 20, 2012 (CN) 201210351855.X

(51) Int. Cl. G09G 3/36

(52) U.S. Cl. CPC G09G 3/3611
USPC 345/87

(57) ABSTRACT

The present disclosure provides a panel video system controller and a liquid crystal display (LCD) device. The panel video system controller includes a timing control circuit and a video processing circuit, and the timing control circuit and the video processing circuit are integrated into a same integrated circuit. In research, data. connection between a back-end system of the LCD device such as television and the LCD panel is mainly achieved by a video processing, chip and the timing control circuit. In the present disclosure, the video processing chip in the back-end system of the LCD device and the timing control circuit in the LCD panel are integrated. On one hand, circuit integration level is increased, and assembly process is simplified. On the other hand, it is not needed to use additional data conversion interface between the back-end system of the LCD device and the LCD panel, thereby reducing the product development cycle, development cost, and assembly process.

### TECHNICAL FIELD

The present disclosure relates to the field of liquid crystal displays (LCDs), and more particularly to a panel video system controller and an LCD device.

### BACKGROUND

A liquid crystal (LC) television is usually made by positioning a back-end system control circuit of the LC television on a liquid crystal panel (LCD) panel module. Both a drive component of the LCD panel module and the back-end system control circuit of the television are completely packaged independently. The LCD panel module includes the LCD panel and a drive circuit board corresponding to the LCD panel, where the drive circuit board is used to drive the LCD panel and display an image. The back-end system control circuit of the television is used to receive and convert signals for different network system. After performing a series of signal processing, the signals are converted into data needed by the LCD panel module and displayed via the drive circuit of the LCD panel, as shown in FIG. 1 and FIG. 2. A complicated data conversion circuit is needed to the LCD panel and system control circuit of a typical LCD television, thereby increasing development cycle and development cost, and the assembly is not convenient.

### SUMMARY

In view of the above-described problems, the aim of the present disclosure is to provide a panel video system controller and a liquid crystal display (LCD) device with the advantages of simple structure, cost reduction and convenient assembly.

The aim of the present disclosure is achieved by the following technical scheme.

A panel video system controller comprises a timing control circuit and a video control circuit, both the timing control circuit and the video control circuit are integrated into the same integrated circuit.

Furthermore, the video processing circuit comprises a video processing module, the timing control circuit comprises a local dimming module, and an output end of the video processing module is directly coupled to the local dimming module. Thus, an interface between the timing control circuit and the video processing circuit chip may be omitted, and even the local dimming module of the timing control circuit can directly deal with data after the video processing module of the video processing circuit finishes data processing without performing additional data format conversion.

Furthermore, the panel video system controller further comprises a memory module, and the memory module is coupled to the timing control circuit and the video processing circuit. Both the timing control circuit and the video processing circuit are connected to the memory module, thereby sharing the memory. Thus, memory components are saved, cost is reduced, integration is further increased, size of integrated chip is reduced, and printed circuit board (PCB) space is saved.

Furthermore, the panel video system controller further comprises a memory module, and the memory module is coupled to the timing control circuit and the video processing circuit. The video processing circuit comprises a video processing module, the timing control circuit comprises a local dimming module, and an output end of the video processing module is directly coupled to the local dimming module. Thus, an interface between the timing control circuit and the video processing circuit chip may be omitted, and even the local dimming module of the timing control circuit can directly deal with data after the video processing module of the video processing circuit finishes data processing without performing additional data format conversion. After the video processing circuit. in the back-end system of the LCD device and the timing control circuit in the LCD panel are integrated, the memory is further shared. Thus, one memory chip is saved, the cost is reduced, the integrated level is further increased, the size of integrated chips is reduced, and the PCB space is saved.

Furthermore, the video processing module comprises a video preprocessor connected with a data input end, a dynamic random access memory (DRAM) controller coupled with the video preprocessor, a video back processor coupled with the DRAM controller, a video enhancer coupled with the video back processor, a mixer coupled with the video enhancer, a dithering processor coupled with the mixer, and a first over drive module coupled with the dithering processor. The first over drive module is directly coupled to the local dimming module of the timing control circuit. This is a specific structure of the video processing module.

Furthermore, the DRAM controller is coupled to the memory module. This is a specific connecting circuit of the memory module of the video processing circuit.

Furthermore, the timing control circuit comprises a gamma white tracking module coupled with the local dimming module, a second over drive module coupled with the gamma white tracking module, a timing controller coupled with the second over drive module, and a differential signal communication module coupled with the timing controller. The gamma white tracking module is coupled with the memory module. This is a specific structure of the timing control circuit.

Furthermore, the timing control circuit further comprises an I²C control module coupled with an external memory. This is a circuit structure of expanding memory chip of the timing control circuit.

An LCD device comprises the aforementioned panel video system controller.

Furthermore, the LCD device comprises an LCD panel, and a drive circuit coupled with the LCD panel. The drive circuit comprises a control board connected with the LCD panel, a video circuit board connected with the control board, and a power supply circuit board supplying power to the video circuit board and the control board. The LCD panel video system controller is arranged in the video circuit board.

In research, data connection between a back-end system of the LCD device such as television and the LCD panel is mainly achieved by a video processing chip and the timing control circuit. In the present disclosure, the video processing chip in the back-end system of the LCD device and the timing control circuit in the LCD panel are integrated. On one hand, circuit integration level is increased, and assembly process is simplified. On the other hand, it is not needed to use additional data conversion interface between the back-end system of the LCD device and the LCD panel, thereby reducing product development cycle, development cost, and assembly process.

### BRIEF DESCRIPTION OF FIGURES

FIG. 1 is a schematic diagram of a typical video system controller;

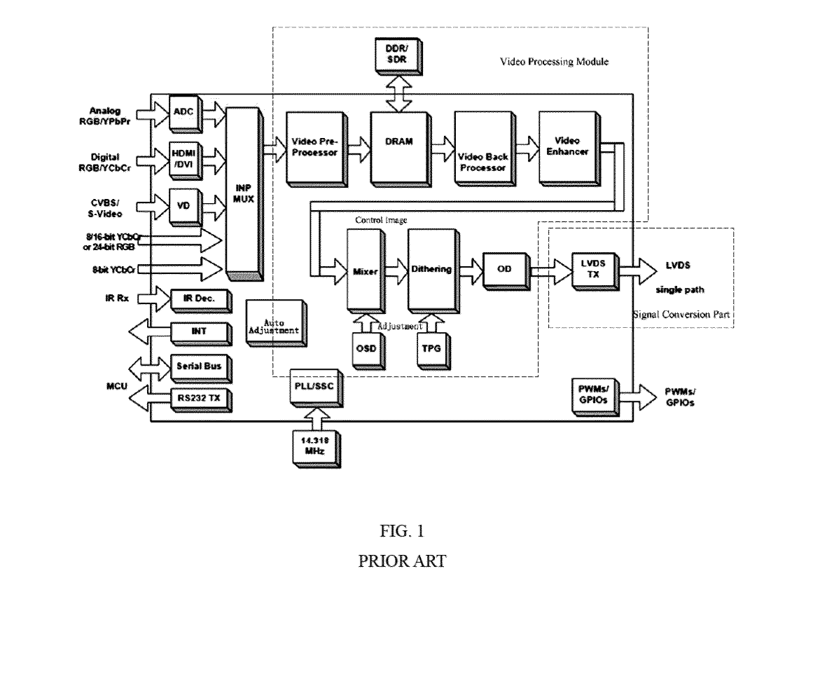

FIG, 2 is a schematic. diagram of a typical timing control circuit;

FIG. 3 is a functional block diagram of a panel video system controller of the prevent disclosure;

FIG. 4 is a circuit diagram of a liquid crystal display (LCD) device of the prevent disclosure;

FIG. 5A is a schematic diagram of a panel video system controller of an example of the present disclosure;

FIG. 5B is a schematic. diagram of a panel video system controller of an example of the present disclosure; and

FIG. 6 is a schematic diagram of an LCD device of the prevent disclosure.

### DETAILED DESCRIPTION

The aim of the present disclosure is achieved by the following technical scheme.

The prevent disclosure provides a liquid crystal display (LCD) device comprising a panel video system controller. The panel video system controller comprises a timing control circuit and a video processing circuit, where the timing control circuit and the video processing circuit are integrated into a same integrated circuit.

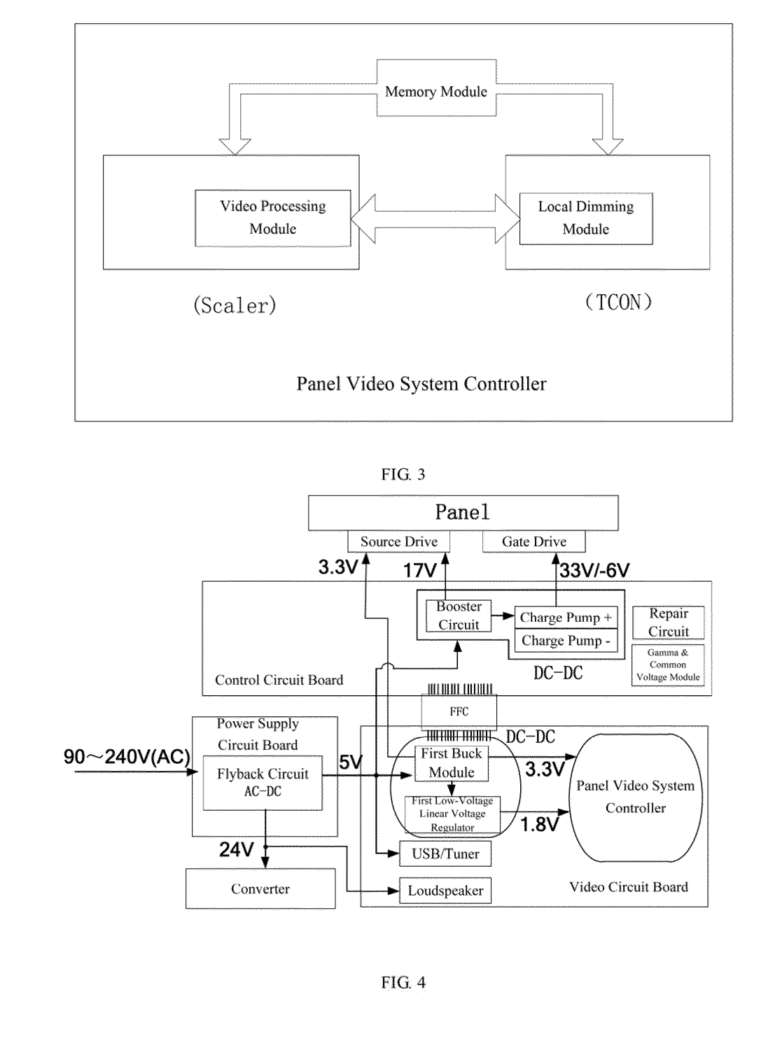

As shown in FIG. 4, the LCD device comprises a LCD panel, and a drive circuit coupled to the panel. The drive circuit comprises a control board connected with the LCD panel, a video circuit board connected with the control board, and a power supply circuit board supplying power to the video circuit board and the control board. The panel video system controller is arranged in the video circuit board.

In research, data connection between a back-end system of the LCD device such as television and the LCD panel is mainly achieved by a video processing chip and the timing control circuit. In the present disclosure, the video processing chip in the back-end system of the LCD device and the timing control circuit in the LCD panel are integrated. On one hand, circuit integration level is increased, and assembly process is simplified. On the other hand, it is not needed to use additional data conversion interface between the back-end system of the LCD device and the LCD panel, thereby reducing product development cycle, development cost, and assembly process.

The present disclosure will further be described in detail in accordance with the figures and the exemplary examples.

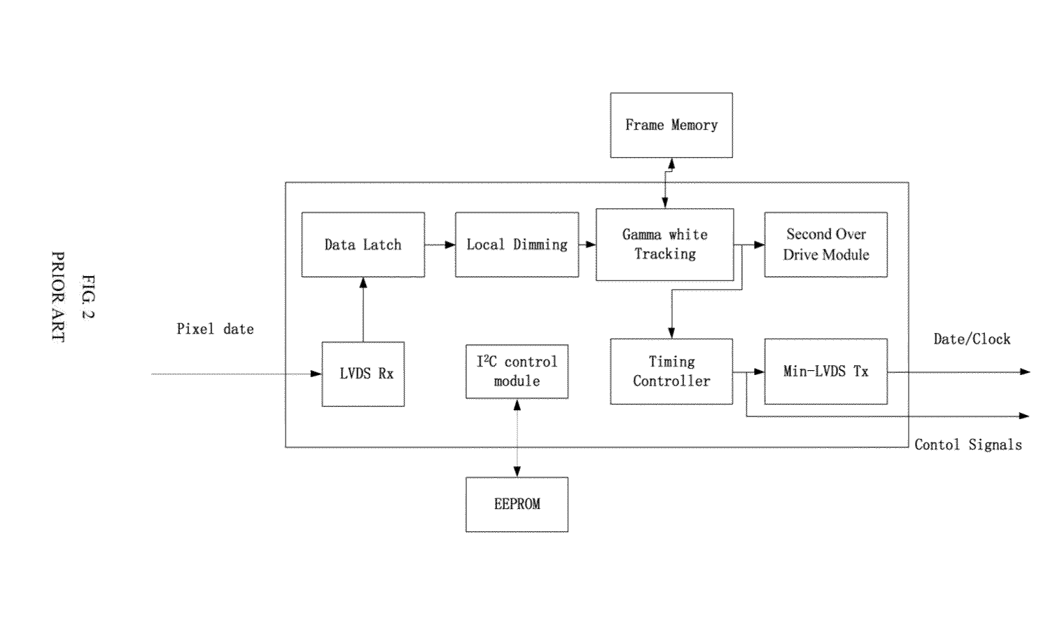

As shown in FIG. 3-FIG. 6, the panel video system controller further comprises a memory module, and the memory module is coupled to the timing control circuit and the video processing circuit. The video processing circuit comprises a video processing module, the timing control circuit comprises a local dimming module, and an output end of the video processing module is directly coupled to the local dimming module. Thus, an interface between the timing control circuit and the video processing circuit chip may be omitted, and the local dimming module of the timing control circuit can directly deal with data after the video processing module of the video processing circuit finishes data processing without performing an additional data format conversion. After the video processing circuit in the back-end system of the LCD device and the timing control circuit in the LCD panel are integrated, the memory module is further shared. Thus, memory components are saved, cost is reduced, integration is further increased, size of integrated chip is reduced, and printed, circuit board (PCB) space is saved.

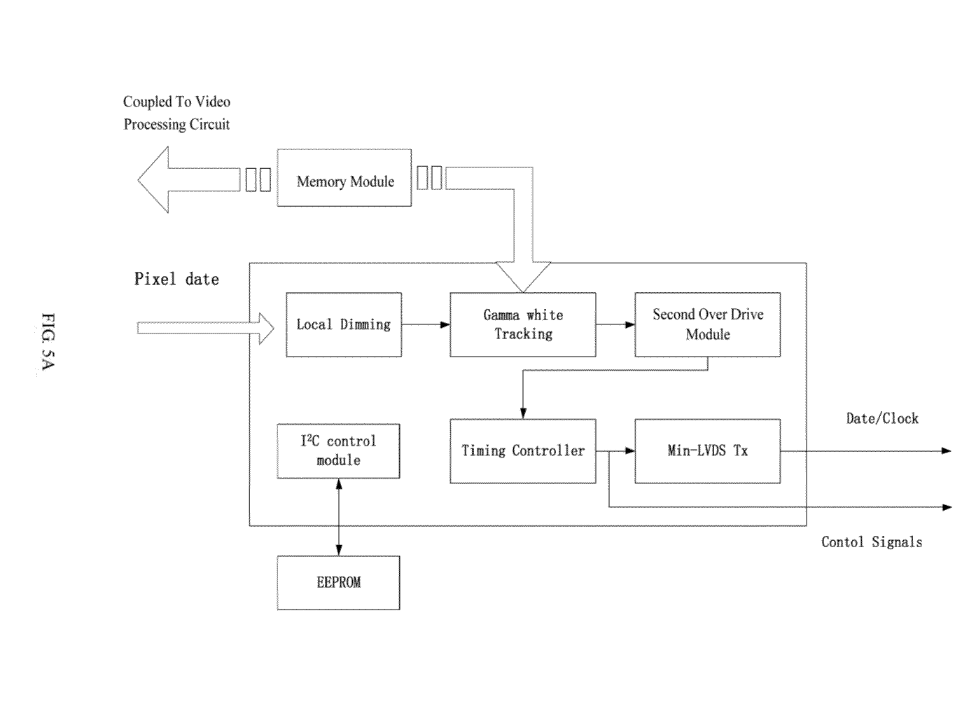

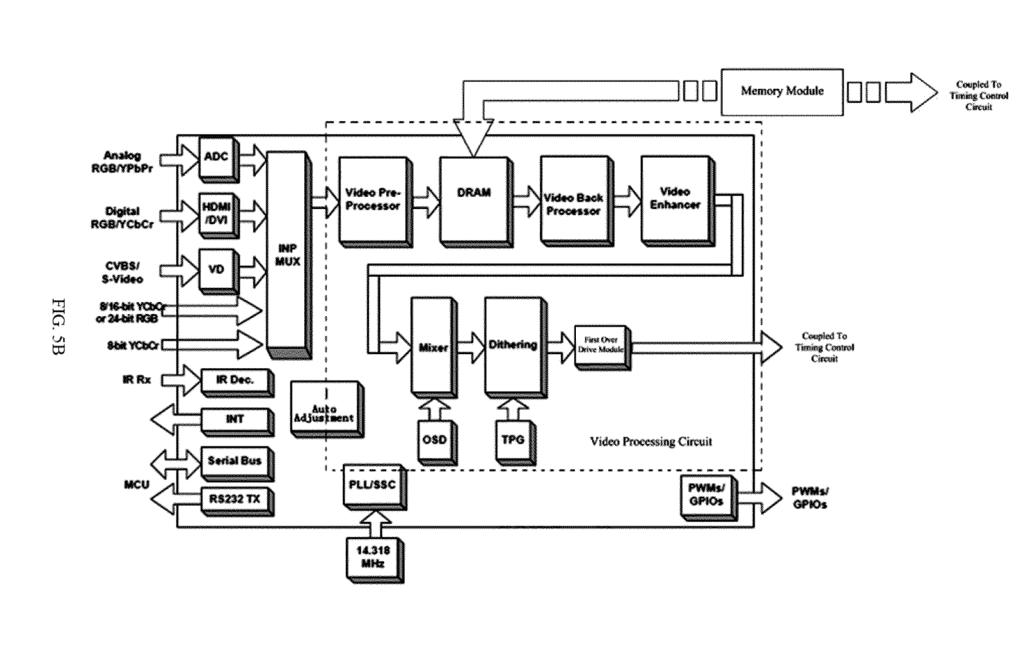

As shown in FIG. 5B, the panel video system controller comprises a video processing module. The video processing module comprises a video preprocessor connected with a data input end, a dynamic random access memory (DRAM) controller coupled with the video preprocessor, a video back processor coupled with the DRAM controller, a video enhancer coupled with the video back preprocessor, a mixer coupled with the video enhancer, as dithering processor coupled with the mixer, and a first over drive module (OD) coupled with the dithering processor. The first over drive module is directly coupled to the local dimming module of the tinting control circuit. The DRAM controller is coupled to the memory module.

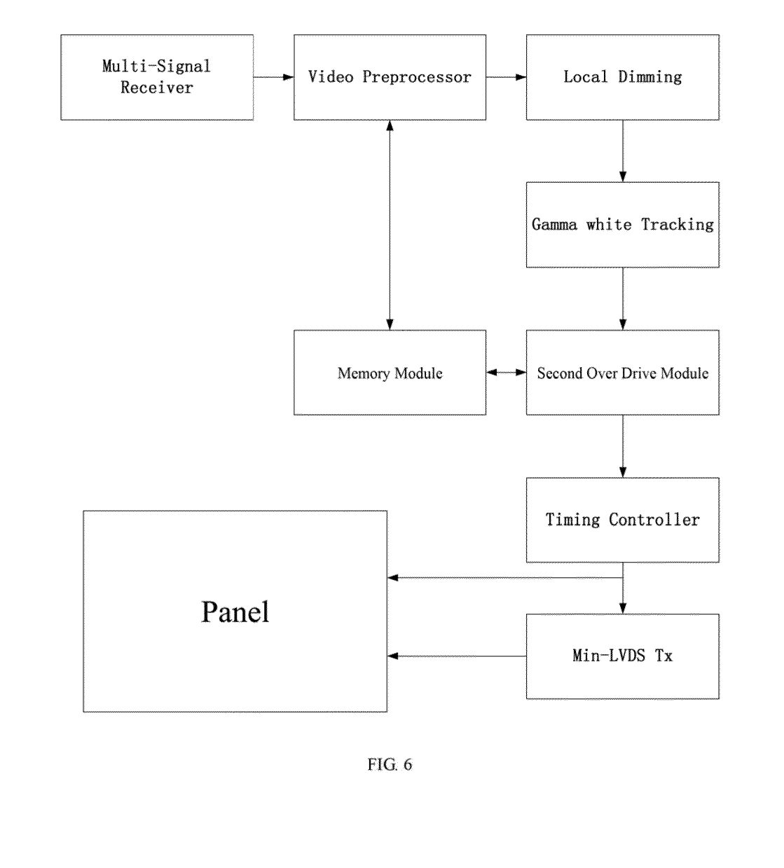

As shown in FIG. 5A, the timing control circuit comprises a gamma white tracking module coupled with the local dimming module, a second over drive module coupled with the gamma. white tracking module, a timing controller coupled with the second over drive module, and a differential signal communication module (Min-LVDS Tx) coupled with the timing controller. The gamma white tracking module is coupled with the memory module. A data/clock signal output by the differential signal communication module is connected to the LCD panel, and a control signal output by the timing controller is also connected to the LCD panel (see FIG. 6). The timing control circuit further comprises an I²C control module coupled with an external memory (EEPROM).

The present disclosure is described in detail in accordance with the above contents with the specific exemplary examples. However, this present disclosure, is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

We claim:

1. A panel video system controller, comprising:
a timing control circuit;
a video processing circuit integrated with a same integrated circuit as the timing control circuit wherein the video processing circuit comprises a video processing module, the timing control circuit comprises a local dimming module, and an output end of the video processing module is directly coupled to the local dimming module; and
a memory module coupled to the timing control circuit and the video processing circuit;
wherein the video processing module comprises a video preprocessor connected with a data input end, a dynamic random access memory (DRAM) controller coupled with the video preprocessor, a video back processor coupled with the DRAM controller, a video enhancer coupled with the video back processor, a mixer coupled with the video enhancer, a dithering processor coupled with the mixer, and a first over drive module coupled with the dithering processor; wherein the first over drive module is directly coupled to the local dimming module of the timing control circuit, the DRAM controller is coupled to the memory module;
wherein the timing control circuit comprises a gamma white tracking module coupled with the local dimming module, a second over drive module coupled with the gamma white tracking module, a timing controller coupled with the second over drive module, and a differential signal communication module coupled with the timing controller; the gamma white tracking module is coupled with the memory module; wherein the timing control circuit further comprises an I²C control module coupled with an external memory.

2. A panel video system controller, comprising:
a timing control circuit; and
a video processing circuit, wherein the timing control circuit and the video processing circuit are integrated into a same integrated circuit.

3. The panel video system controller of claim 2, wherein the video processing circuit comprises a video processing module, the timing control circuit comprises a local dimming module, and an output end of the video processing module is directly coupled to the local dimming module.

4. The panel video system controller of claim 2, wherein the panel video system controller further comprises a. memory module, and the memory module is coupled to the timing control circuit and the video processing circuit.

5. The panel video system controller of claim 2, wherein the panel video system controller further comprises a memory module, and the memory module is coupled to the timing control circuit and the video processing circuit; the video processing circuit comprises a video processing module, the timing control circuit comprises a local dimming module, and an output end of the video processing module is directly coupled to the local dimming module.

6. The panel video system controller of claim 5, wherein the video processing module comprises a video preprocessor connected with a data input end, a dynamic random access memory (DRAM) controller coupled with the video preprocessor, a video back processor coupled with the DRAM controller, a video enhancer coupled with the video back processor, a mixer coupled with the video enhancer, a dithering processor coupled with the mixer, and a first over drive module coupled with the dithering processor; the first over drive module is directly coupled to the local dimming module of the timing control circuit.

7. The panel video system controller of claim 6, wherein the DRAM controller is coupled to the memory module.

8. The panel video system controller of claim 5, wherein the timing control circuit comprises a gamma white tracking module coupled with the local dimming module, a second over drive module coupled with the gamma white tracking module, a timing controller coupled with the second over drive module, and a differential signal communication module coupled with the timing controller;
the gamma white tracking module is coupled with the memory module.

9. The panel video system controller of claim 8, wherein the timing, control circuit further comprises an I²C control module coupled with an external memory.

10. A liquid crystal display (LCD) device, comprising:
a panel video system controller, wherein the panel video system controller comprises a timing control circuit and a video processing circuit, the timing control circuit and the video processing circuit are integrated into a same integrated circuit.

11. The liquid crystal display (LCD) device of claim 10, wherein the video processing circuit comprises a video processing module, the timing control circuit comprises a local dimming module, and an output end of the video processing module is directly coupled to the local dimming module.

12. The liquid crystal display (LCD) device of claim 10, wherein the panel video system controller further comprises a memory module, and the memory module is coupled to the timing control circuit and the video processing circuit.

13. The liquid crystal display (LCD) device of claim 10, wherein the panel video system controller further comprises a memory module, and the memory module is coupled to the timing control circuit and the video processing circuit the video processing circuit comprises a video processing module, the timing control circuit comprises a local dimming module, and an output end of the video processing module is directly coupled to the local dimming module.

14. The liquid crystal display (LCD) device of claim 13, wherein the video processing module comprises a video preprocessor connected with a data input end, a dynamic random access memory (DRAM) controller coupled with the video preprocessor, a video back processor coupled with the DRAM controller, a video enhancer coupled with the video back processor, a mixer coupled with the video enhancer, a dithering processor coupled with the mixer, and a first over drive module coupled with the dithering processor; the first over drive module is directly coupled to the local dimming module of the timing control circuit.

15. The liquid crystal display (LCD) device of claim 14, wherein the DRAM controller is coupled to the memory module.

16. The liquid crystal display (LCD) device of claim 13, wherein the timing control circuit comprises a gamma white tracking module coupled with the local dimming module, a second over drive module coupled with the gamma white tracking module, a timing controller coupled with the second over drive module, and a differential signal communication module coupled with the timing controller; the gamma white tracking, module is coupled with the memory module.

17. The liquid crystal display (LCD) device of claim 16, wherein the timing control circuit further comprises an I²C control module coupled with an external memory.

18. The liquid crystal display (LCD) device of claim 10, wherein the LCD device comprises an LCD panel, and a drive circuit coupled with the LCD panel; the drive circuit comprises a control board connected with the LCD panel, a video circuit board connected with the control hoard, and a power supply circuit board supplying power to the video circuit board and the control board; the LCD panel video system controller is arranged in the video circuit board.
